(19) United States
(12) Patent Application Publication
(10) Pub. No.: US 2025/0180314 A1
(43) Pub. Date: Jun. 5, 2025

(54) 3D Printed Bolt Receiver with side anchor surfaces

(71) Applicant: Bobby McCreight, Bulverde, TX (US)

(72) Inventor: Bobby McCreight, Bulverde, TX (US)

(21) Appl. No.: 18/968,838

(22) Filed: Dec. 4, 2024

Related U.S. Application Data
(60) Provisional application No. 63/619,921, filed on Jan. 11, 2024.
(60) Provisional application No. 63/605,832, filed on Dec. 4, 2023.

(51) Int. Cl. F41A 3/66; B33Y 80/00; F41G 11/00

(52) U.S. Cl. CPC F41A 3/66; B33Y 80/00; F41G 11/003

(57) ABSTRACT

A receiver features integrally formed side anchor points for mounting accessories, enhancing the receiver's adaptability and functionality. The receiver is fabricated using metal 3D printing technology, allowing for unique geometric features and the incorporation of anchor points that extend outward from the receiver's profile. These anchor points consist of mounting hole boss sets and indexing pin hole bosses located on both the left and right sides of the receiver at proximal and distal positions. They include threaded holes for securely attaching supplementary devices such as optics, lasers, pointers, and other accessories, enabling them to recoil as a unit and remain within easy reach of the shooter. The receiver also includes a Picatinny rail integrally formed along its top surface, which may extend cantilevered beyond the distal end for additional accessory mounting. By providing these side anchor points and utilizing advanced manufacturing techniques, the invention overcomes the limitations of traditional receivers that lack surfaces for mounting supplementary devices directly on the receiver itself. This design improves the structural rigidity of the receiver and is applicable not only to bolt-action firearms but also to other types of firearm actions where enhanced rigidity and additional mounting points are desirable.

### RELATED APPLICATIONS

This application claims the benefit under 35 USC 119 (e) of U.S. Provisional Application No. 63/619,921, filed Jan. 11, 2024, and U.S. Provisional Application No. 63/605,832, filed Dec. 4, 2023, both of which are incorporated herein by reference in their entirety.

### BACKGROUND OF THE INVENTION

Bolt Action (BA) is a type of firearm mechanism commonly used in rifles that involves manually operating a bolt to load cartridge into the chamber as well as to extract and eject the cartridge after the firing. Bolt action rifles are widely used and known for their reliability, accuracy and simplicity, and have been broadly used in hunting, precision shooting and military. Key parts of the bolt action include the bolt assembly which consists of bolt body, bolt handle, firing pin, extractor and ejector, and locking lugs.

A bolt receiver is a component that functions as a shroud or housing that encloses the bolt assembly and that serves multiple purposes: as pressure vessel protection and aesthetic enhancement as well as functional and practical design geometry. It acts as the primary housing for the bolt assembly allowing it to cycle and provides structural framework for other critical components of the firearm such as a primary optic surface located at the top-center of the receiver as has been done since its inception. The receiver sits between the firearm's barrel and stock or chassis.

The stock, traditionally, is made from wood, but is currently often an aluminum, plastic or composite chassis, designed to support the barreled action. This also provides a comfortable and stable platform for aiming and firing. It has a variety of shapes and can be customizable for ergonomic and shooting needs.

Modern chassis are a traditional stock replacement that offer modularity, allowing adjustments in length of pull, comb height and attachment points for accessories such as rails, and other shooting aids. These chassis are often manufactured from aluminum, composites, or other durable materials and provide more customization options in precision shooting or tactical applications.

A recoil lug is a crucial component in rifles as well. The primary purpose of a recoil lug is recoil management and alignment. Particularly in the bolt-action receiver, it helps to manage the forces generated by the firing of a round by transferring those forces to the stock or chassis. It is often small, usually a flat metal piece located between the barrel and the action of the rifle and often is integral with the bolt receiver. The barrel passes through the recoil lug and the lug itself is sandwiched between receiver and the stock during assembly. Typically, a recoil lug is located at the front of the receiver, in the location where the barrel is threaded into the receiver.

The most commonly used material for receivers and bolt assemblies is steel such as carbon steel and stainless steel, which gives a high tensile strength to withstand firing pressure. Other possible materials include nickel alloys, aluminum, steel, titanium and carbon fiber. Aluminum alloy receivers are lightweight and corrosion-resistant and are often used in modern lightweight firearms, particularly semi-automatic rifles and carbines.

Many receivers have an integrated mounting rail located at the 12-oclock position allowing for the primary day optic, or screw holes to affix such a rail or optic.

### SUMMARY OF THE INVENTION

Conventional receivers have maintained a consistent geometric profile over time, with design variations that encompass round, rounded-angular or semi-squared facing configurations. Modern receivers often have an irregular shape for easier hardware mounting and operation.

A limitation of traditional receivers is the absence of locations or surfaces for mounting supplementary devices on the stock, chassis, and/or receiver itself. This limitation restricts the adaptability of the receivers to accommodate diverse user requirements.

The embodiments of the present invention resolve this issue. They encompass attributes aimed at providing side anchor points on a firearm receiver. Some anchors extend into the region (according to the fore-aft axis) of the recoil lug to provide added function. Also, the anchors provide strength to the receiver and locations to mount hardware accessories including additional optics, lasers, pointers and other devices allowing them to recoil as a unit from a foundational location within easy reach of the shooter.

The present invention relates to an improved firearm receiver designed to enhance adaptability and functionality by incorporating integrally formed anchor points for mounting accessories. The receiver is preferably fabricated using metal additive manufacturing processes, such as metal 3D printing techniques including Selective Laser Melting (SLM), Direct Metal Laser Sintering (DMLS), or Electron Beam Melting (EBM). This advanced fabrication method allows for the creation of complex geometries and monolithic structures, integrating features that were previously difficult or impossible to achieve with traditional manufacturing techniques.

At least one anchor point is preferably integrally formed with the receiver during the metal 3D printing process. These anchor points comprise a plurality of mounting hole bosses extending laterally from the receiver's main body. The mounting hole bosses project outward from the receiver's profile by several such as at least 3 millimeters, providing sufficient space for secure attachment of accessories. The bosses include threaded holes configured to receive fastening hardware, enabling the attachment of various accessories such as optics, lasers, pointers, and other devices.

In addition to the mounting hole bosses, the receiver often further comprises indexing pin hole bosses located below the anchor points. These indexing pin hole bosses are configured to receive indexing pins for precise accessory alignment. Both the mounting hole bosses and the indexing pin hole bosses terminate at a contiguous planar surface for securing accessories. This planar surface can be post-processed, such as by lapping, to achieve a smooth finish that enhances the contact between the accessory and the receiver.

The anchor points are strategically positioned on the receiver to maximize utility and accessibility. One or more anchor points can be located on a side of the receiver proximal to an ejection port, positioned above the centerline of the barrel's axis by at least 2 millimeters. This placement allows for easy access and does not interfere with the ejection of spent cartridges. Additional anchor points may be located on the distal end portion of the receiver, forward of the ejection port, providing further options for accessory mounting.

The receiver also can include a Picatinny rail integrally formed along the top surface. The Picatinny rail extends cantilevered beyond the distal end of the receiver by at least 5 millimeters, offering an extended platform for mounting primary optics such as scopes or telescopic sights. The integration of the Picatinny rail during the metal 3D printing process ensures a robust and precise alignment with the receiver.

The firearm receiver is preferably fabricated as a monolithic structure, with the receiver and all integrally formed components, including the anchor points and Picatinny rail, produced in a single manufacturing process. This monolithic construction enhances the structural integrity and durability of the receiver, reducing potential weak points associated with assembly joints.

While the receiver is suited for bolt-action firearms, the design principles and features are applicable to various types of firearms, including lever-action, pump-action, semi-automatic, and fully automatic firearms. The incorporation of integrally formed anchor points and the use of advanced metal additive manufacturing processes allow for enhanced rigidity, customization, and functionality across a wide range of firearm platforms.

In one embodiment, the at least one anchor point comprises a left side proximal mounting hole boss set located near a proximal end of the receiver and a left side distal mounting hole boss set located near a distal end of the receiver. These anchor points provide versatile mounting options for accessories that need to be within easy reach of the shooter. In another embodiment, the receiver further comprises a right side mounting hole boss set mirroring the left side mounting hole boss sets on the opposite side of the receiver, offering symmetrical accessory mounting capabilities.

By utilizing metal 3D printing technology to integrate anchor points and other features directly into the firearm receiver, the invention overcomes the limitations of traditional receivers that lack surfaces for mounting supplementary devices directly on the receiver itself. This innovative design enhances the receiver's adaptability, structural rigidity, and overall functionality, meeting the diverse requirements of modern firearm users.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective view of a traditional bolt receiver, of which all or most parts are extruded, machined from billet material or forged in techniques that economically disallow eccentric surfaces, unique protrusions or geometric freedom;

FIG. 2 is a top view of a traditional bolt receiver;

FIG. 3 is a perspective left side view of a bolt receiver according to the present invention;

FIG. 4 is a perspective right side view of the bolt receiver according to the present invention; and

FIG. 5 is a top view of the bolt receiver according to the present invention.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

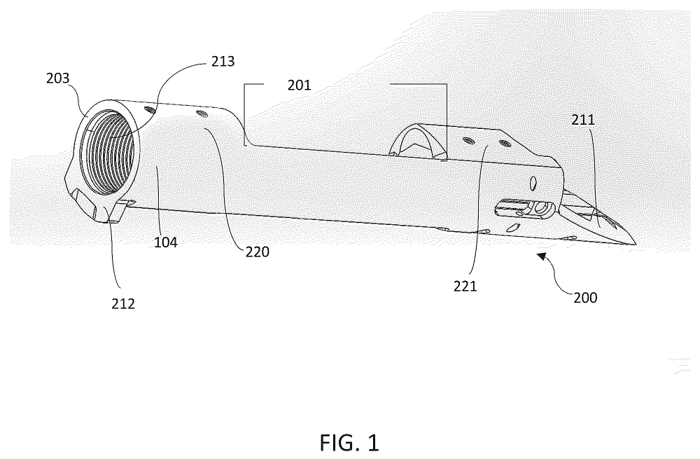

FIG. 1 is a perspective view of a traditional bolt-action receiver, of which all or most are extruded, machined from billet material or forged in techniques that economically disallow eccentric surfaces, unique protrusions or geometric freedom.

The traditional bolt-action receiver 200 generally consists of proximal end portion 211, distal end portion 203, ejection port 201, proximal receiver bridge 221, a distal receiver bridge 220, and barrel boss 104. Traditionally, the bolt-action receiver has considerable material removed in order to provide side opening of the bolt action for an ejection port to eject casings laterally outward. Therefore, around ejection port 201 there are weak points that significantly reduce the rigidity of the receiver as well as allowing flex but eventual fatigue of the receiver over time. The proximal receiver bridge 221 and barrel boss 104, as well as distal receiver bridge 220 all provide the bolt receiver some rigidity, however, not enough to ensure its rigidity and heighten its resistance to flexure and fatigue.

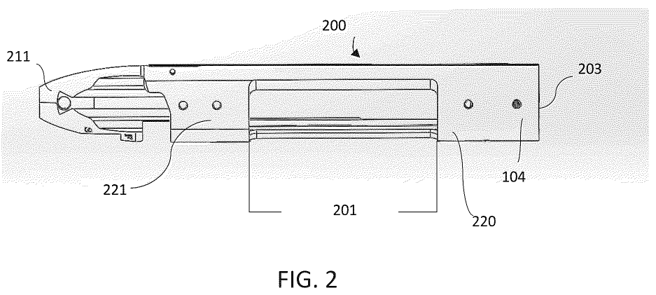

FIG. 2 is a top view of a traditional bolt receiver 200.

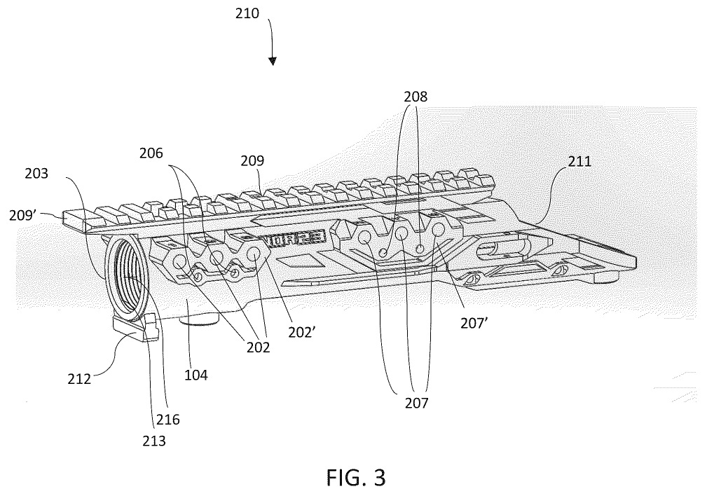

FIG. 3 is a perspective left side view of a firearm receiver 210 according to the present invention.

The receiver 210 in some examples is made using traditional machining techniques. In the preferred embodiment, however, it is fabricated using metal 3D printing, or metal additive manufacturing. In general, when made additively, the receiver 210 is built layer by layer by fusing metal materials in different forms such as powder, wire, or sheets. Key types of additive manufacturing that can be used include Selective Laser Melting (SLM) and Direct Metal Laser Sintering (DMLS), which use high-powered lasers to fully melt or sinter metal powders in a powder bed to create precise, high-strength parts; Electron Beam Melting (EBM), similar to SLM but utilizing an electron beam in a vacuum chamber, ideal for materials like titanium; Binder Jetting, where a liquid binder selectively adheres metal powder particles that are later sintered in a furnace, suitable for complex geometries without requiring full density; Directed Energy Deposition (DED), which melts metal feedstock—either powder or wire—as it is deposited, allowing for the creation or repair of large-scale components; and Metal Extrusion processes like Bound Metal Deposition, where metal powder bound with a polymer is extruded and later sintered to form solid metal parts.

As is conventional, the receiver 210 includes a recoil lug 212 on the underside of the receiver at or near the distal end portion 203. This lug 212 is in the region of the barrel boss 104 and is also integral with the rest of the receiver 210 and fabricated as part of the metal 3D printing process used to fabricate the receiver 210.

The receiver has a reinforcing feature 218 in the region of and preferably below the ejection port 218.

A Picatinny rail 209 is located on the upper portion of the receiver 210. Preferably this is fabricated using metal 3D printing when entire receiver 210 is rendered. In the illustrated example, it extends along the entire top surface, extending above ejection port 201 and above barrel boss 104. Preferably, the rail 209 further projects as a cantilever beyond the distal end portion 203. This cantilevered portion of 209′ is usually greater than 5 millimeters (mm) long but often less than 30 mm long.

A left side distal mounting hole boss set 202 provides a left side distal side anchor point for accessories. Preferably this is fabricated using metal 3D printing when entire receiver 210 is rendered. The left side distal mounting hole boss set 202 is provided as a set of three bosses projecting laterally from the main body of the receiver 210, ending in a contiguous planar surface of 202′ to which an accessory can be securely clamped via bolts screwed into the boss set 202. The holes defined by these bosses are threaded, preferably ¼″ holes with a 28 thread pitch. In other examples, the threads are M5×0.8 mm thread, M4×0.7 mm thread or M6×1.0 mm. Preferably, the holes are threaded in a post processing step after the receiver body has been metal additively manufactured.

Preferably, the boss 202 extend outward from the profile of the receiver by at least 1 millimeter for more. Preferably, they extend outward from the profile by several millimeters such as 3 or more, or 4 or more, or 5 or more millimeters.

In other examples, fewer than three bosses can be used such as one or two. In still other examples, more than three bosses can be used such as four or five.

The left side distal mounting hole boss set 202 is located along the length of the receiver near the distal end. The left side distal mounting hole boss set 202 is located vertically above the centerline of the barrel's axis 216 by more than 1 millimeter such as more than 2 mm or 3 mm or 4 mm and projects laterally outward orthogonally to the longitudinal axis or centerline of the receiver and horizontally.

Below the left side distal mounting hole boss set 202 are two left side distal indexing pin hole bosses 206 to receive indexing pins for holding a device that attaches to the receiver 210 with bolts engaging with the threaded holes of the left side distal mounting hole boss set 202. Preferably this is fabricated using metal 3D printing when the entire receiver 210 is rendered. Preferably the two left side distal indexing pin hole bosses 206 project outward from the centerline 216 ending at the contiguous planar surface of 202 also encompassing the left side distal mounting hole boss set 202. This surface is often lapped after the receiver has been metal 3D printed in some examples to provide a smooth contiguous surface.

A left side proximal mounting hole boss set 207 is also provided as another set of three bosses projecting laterally from the main body of the receiver 210, at the left proximal side anchor point for accessories. Preferably this set is fabricated using metal 3D printing when the entire receiver 210 is rendered. The left side proximal mounting hole boss set 207 is located along the length of the receiver near the proximal end. The left side proximal mounting hole boss set 207 is also located above the centerline of the barrel's axis 216 by more than 1 millimeter such as more than 2 mm or 3 mm or 4 mm and projects laterally outward orthogonally to the longitudinal centerline of the receiver 210 and horizontally. Preferably, the boss set 207 extend outward from the profile of the receiver by at least 1 millimeter for more. Preferably, they extend outward from the profile by several millimeters such as 3 or more, or 4 or more, or 5 or more millimeters. The holes defined by these bosses are also threaded, preferably ¼″ holes with a 28 thread pitch or M5×0.8 mm thread, M4×0.7 mm thread or M6×1.0 mm.

Below the left side proximal mounting hole boss set 207 are two left side proximal indexing pin hole bosses 208 to receive indexing pins for holding a device that attaches to the receiver 210 with bolts engaging with the threaded holes of the left side proximal mounting hole boss set 207. Preferably this is fabricated using metal 3D printing when the entire receiver 210 is rendered.

Preferably the left side proximal mounting hole boss set 207 and the two left side proximal indexing pin hole bosses 208 project outward from the centerline 216 ending at a contiguous planar surface of 207′. This surface is often lapped after the receiver has been metal 3D printed in some examples to provide a smooth contiguous surface.

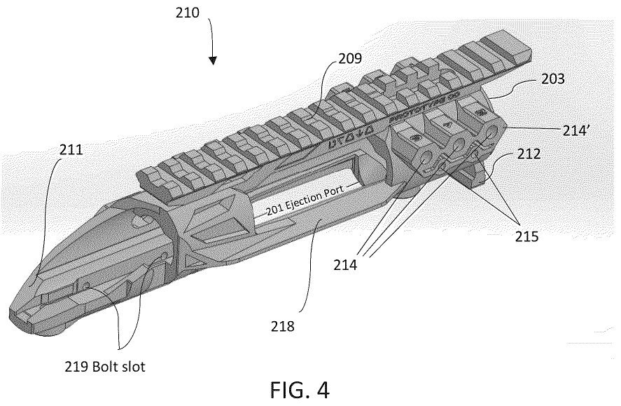

FIG. 4 is a perspective right side of the bolt receiver 210 according to the present invention.

A right side distal mounting hole boss set 214 is provided as a set of three bosses projecting laterally from the main body of the receiver 210 providing a right side distal accessory anchor point. Preferably this is fabricated using metal 3D printing when the entire receiver 210 is rendered. Preferably, the boss set 214 extend outward from the profile of the receiver by at least 1 millimeter for more. Preferably, they extend outward from the profile by several millimeters such as 3 or more, or 4 or more, or 5 or more millimeters. The holes defined by these bosses are also threaded often as a post 3D printing machining process, preferably ¼″ holes with a 28 thread pitch or M5×0.8 mm thread, M4×0.7 mm thread or M6×1.0 mm.

The right side distal mounting hole boss set 214 is located along the length of the receiver near the distal end and forward of the ejection port 201. The right side distal mounting hole boss set 214 is located above the centerline of the barrel's axis by more than 1 millimeter such as more than 2 mm or 3 mm or 4 mm and projects laterally outward orthogonally to the longitudinal centerline of the receiver.

Below the right side distal mounting hole boss set 214 are two right side distal indexing pin hole bosses 215 to receive indexing pins for holding a device that attaches to the receiver 210 with bolts engaging with the threaded holes of the right side distal mounting hole boss set 215.

Preferably the right side distal mounting hole boss set 214 and the two right side distal indexing pin hole bosses 215 project outward from the centerline 216 also ending at a contiguous planar surface of 214′ that is often lapped smooth after the printing process.

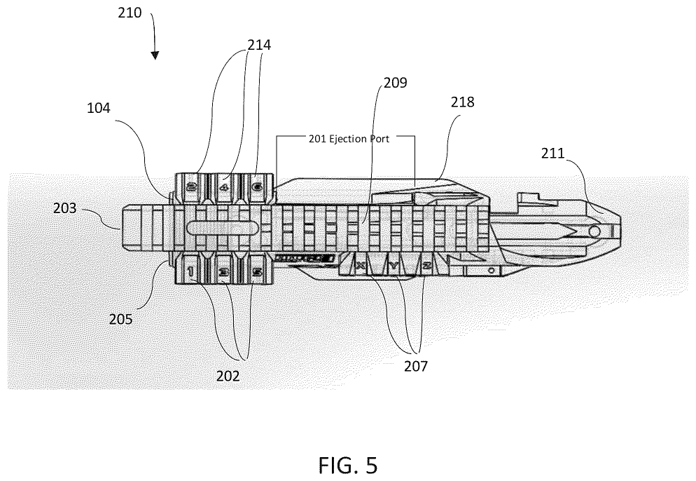

FIG. 5 is a top view of the bolt receiver according to the present invention.

As shown, the left side proximal mounting hole boss set 207 is located fore-aft on the receiver 210 at a point where the mid-point of the boss set 207 falls near the proximal beginning of the ejection port 201 on the opposite side of the receiver 210. In preferably the mid-point of the boss set 207 is 3 mm or 4 mm or 5 mm or more, distal of the proximal beginning of the ejection port 201.

On the other hand, the left side distal mounting hole boss set 202 and the right side distal mounting hole boss set 214 are located forward of the ejection port 201 in the region of the barrel boss 104 and rearward of the barrel mating surface 205.

According to a method of use, in a typical case, the Picatinny rail 209 is used to secure a main optic such as a rife scope or telescopic sight, and preferably a scope providing magnification such as 1.5× or 2× or more of magnification. On the other hand, the left side proximal mounting hole boss set 207 receives a reflex sight, i.e., a sight that has a reflective glass element to superimpose an illuminated reticle, such as a dot or other aiming point, onto the shooter's field of view or other non-magnifying optical sight.

According to another method of use, the right side distal mounting hole boss set 214 receives a reflex sight or other non-magnifying optical sight.

When a night sighting system is desired, it can be mounted to either or both of the left side proximal mounting hole boss set 207 and the left side distal mounting hole boss set 202, especially when the sighting system is physically large. Such a sighting system is often a traditional night vision device employing image intensification technology. A thermal imaging system that detects infrared radiation emitted as heat by objects is another option as is a digital night vision that combines low-light sensors with digital signal processing to display images on a screen. A fusion system is still another option, which integrates image intensification and thermal imaging technologies to overlay thermal data onto intensified images, providing a more comprehensive view that highlights both the detailed visual scene and the heat signatures within it.

While this invention has been particularly shown and described with references to preferred embodiments thereof, it will be understood by those skilled in the art that various changes in form and details may be made therein without departing from the scope of the invention encompassed by the appended claims.

What is claimed is:

1. A firearm receiver, the comprising:
at least one anchor point;
wherein at least one anchor point is metal 3D printed with the receiver.

2. The firearm receiver of claim 1, wherein the at least one anchor point comprises a plurality of mounting hole bosses extending laterally from the receiver's main body.

3. The firearm receiver of claim 2, wherein the mounting hole bosses include threaded holes configured to receive fastening hardware.

4. The firearm receiver of claim 2, wherein the mounting hole bosses project outward from the receiver's profile by at least 3 millimeters.

5. The firearm receiver of claim 1, further comprising indexing pin hole bosses located below the at least one anchor point, configured to receive indexing pins for accessory alignment.

6. The firearm receiver of claim 5, wherein the indexing pin hole bosses and the mounting hole bosses terminate at a contiguous planar surface for securing accessories.

7. The firearm receiver of claim 6, wherein the contiguous planar surface is post-processed to achieve a smooth finish.

8. The firearm receiver of claim 1, wherein the at least one anchor point is located on a side of the receiver proximal to an ejection port.

9. The firearm receiver of claim 8, wherein the at least one anchor point is positioned above the centerline of the barrel's axis by at least 2 millimeters.

10. The firearm receiver of claim 1, wherein the at least one anchor point is located on a distal end portion of the receiver forward of an ejection port.

11. The firearm receiver of claim 1, further comprising: a Picatinny rail integrally formed along a top surface of the receiver.

12. The firearm receiver of claim 11, wherein the Picatinny rail extends cantilevered beyond a distal end of the receiver by at least 5 millimeters.

13. The firearm receiver of claim 1, wherein the receiver and the at least one anchor point are fabricated as a monolithic structure using a metal additive manufacturing process selected from the group consisting of Selective Laser Melting (SLM), Direct Metal Laser Sintering (DMLS), or Electron Beam Melting (EBM).

14. The firearm receiver of claim 1, wherein the receiver is configured for use in a firearm selected from the group consisting of lever-action, pump-action, semi-automatic, and fully automatic firearms.

15. The firearm receiver of claim 1, wherein the at least one anchor point comprises:
a left side proximal mounting hole boss set located near a proximal end of the receiver; and
a left side distal mounting hole boss set located near a distal end of the receiver.

16. The firearm receiver of claim 15, further comprising a right side mounting hole boss set mirroring the left side mounting hole boss sets on the opposite side of the receiver.

17. A method of manufacturing and using a firearm receiver comprising:
fabricating the firearm receiver using a metal additive manufacturing process to produce a monolithic structure that includes:
a main body of the receiver; and
at least one anchor point integrally formed with and extending laterally from the main body;
wherein the at least one anchor point comprises a plurality of mounting hole bosses projecting outward from the receiver's profile;
simultaneously attaching different optics to the anchor points.
